(19) United States
(12) Patent Application Publication
(10) Pub. No.: US 2009/0184792 A1
(43) Pub. Date: Jul. 23, 2009

(54) COMPLEX COMMON MODE CHOKE

(76) Inventor: Sen-Tai Yang, Yin-Ko Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/017,647

(22) Filed: Jan. 22, 2008

(51) Int. Cl. H01F 38/08; H01F 27/06

(52) U.S. Cl. 336/65

(57) ABSTRACT

A complex common mode choke includes a base provided with two receiving recesses and a separation groove between the receiving recesses, a coil unit including two coil bobbins each mounted in a respective one of the two receiving recesses of the base and two coils each mounted on a respective one of the two coil bobbins, and an iron core mounted in the separation groove of the base and having two sides each located adjacent to and aligned with a respective one of the two coil bobbins and a respective one of the two coils. Thus, the iron core is located between the coils, and the surface area of each of the two opposite sides of the iron core can be adjusted so as to change the leakage inductance between the two coil bobbins.

### BACKGROUND OF THE INVENTION

1. Field of the Invention

The present invention relates to a common mode choke and, more particularly, to a complex common mode choke.

2. Description of the Related Art

An electronic equipment is easily interrupted by an electromagnetic interference (EMI) which usually comes from switching actions of multiple power semiconductors. The EMI generally includes a common mode noise and a differential mode noise.

A conventional transformer 2 in accordance with the prior art shown in FIG. 4 comprises an alternating current power supply input terminal 21, a common mode choke 22, a differential mode choke 23, a rectifier 24 and a direct current power supply output terminal 25. Thus, the common mode choke 22 can be used to eliminate the common mode noise, and the differential mode choke 23 can be used to eliminate the differential mode noise. However, the transformer 2 has a larger volume due to provision of the common mode choke 22 and the differential mode choke 23, so that the transformer 2 is not made easily and has a higher cost of fabrication.

### BRIEF SUMMARY OF THE INVENTION

In accordance with the present invention, there is provided a complex common mode choke, comprising a base provided with two receiving recesses and a separation groove located between the two receiving recesses, a coil unit mounted on the base and including two coil bobbins each mounted in a respective one of the two receiving recesses of the base and two coils each mounted on a respective one of the two coil bobbins, and an iron core mounted in the separation groove of the base and having two opposite sides each located adjacent to and aligned with a respective one of the two coil bobbins and a respective one of the two coils.

The primary objective of the present invention is to provide a complex common mode choke that has a reduced volume and has a lower cost of fabrication.

Another objective of the present invention is to provide a complex common mode choke, wherein the iron core is located between the two coils of the coil unit, and the surface area of each of the two opposite sides of the iron core can be adjusted so as to change the leakage inductance between the two coil bobbins of the coil unit.

A further objective of the present invention is to provide a complex common mode choke that can replace the common mode choke and the differential mode choke of the conventional transformer so as to reduce the whole volume and decrease the costs of fabrication of the transformer largely.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a circuit layout of a transformer in accordance with the preferred embodiment of the present invention.

FIG. 2 is a partially exploded perspective view of a complex common mode choke of the transformer as shown in FIG. 1.

FIG. 3 is an exploded perspective view of the complex common mode choke as shown in FIG. 2.

FIG. 4 is a circuit layout of a conventional transformer in accordance with the prior art.

### DETAILED DESCRIPTION OF THE INVENTION

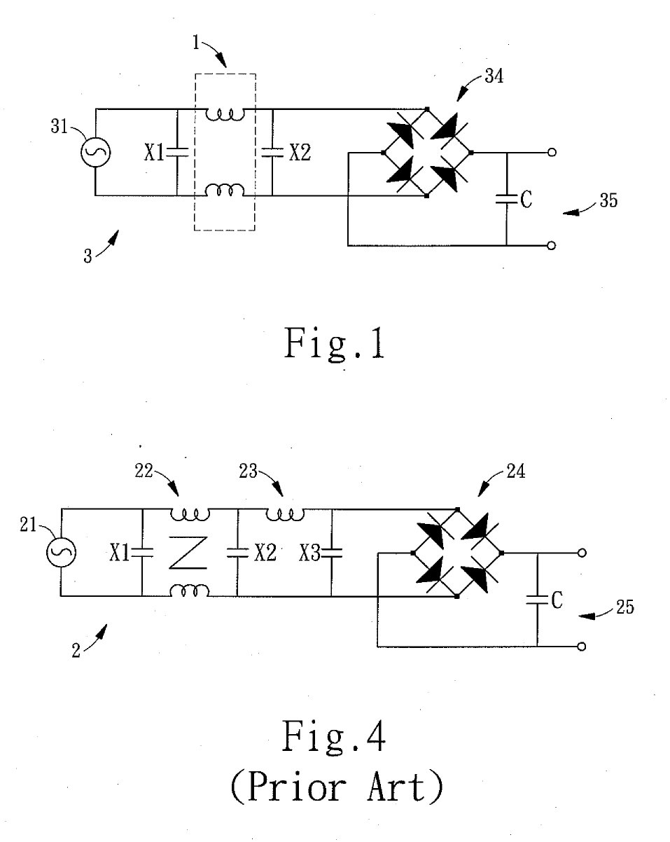

Referring to the drawings and initially to FIG. 1, a transformer 3 in accordance with the preferred embodiment of the present invention comprises an alternating current power supply input terminal 31, a complex common mode choke 1, a rectifier 34 and a direct current power supply output terminal 35. In such a manner, the complex common mode choke 1 of the transformer 3 in accordance with the preferred embodiment of the present invention can replace the common mode choke 22 and the differential mode choke 23 of the conventional transformer 2 in accordance with the prior art so as to reduce the whole volume of the transformer 3 largely.

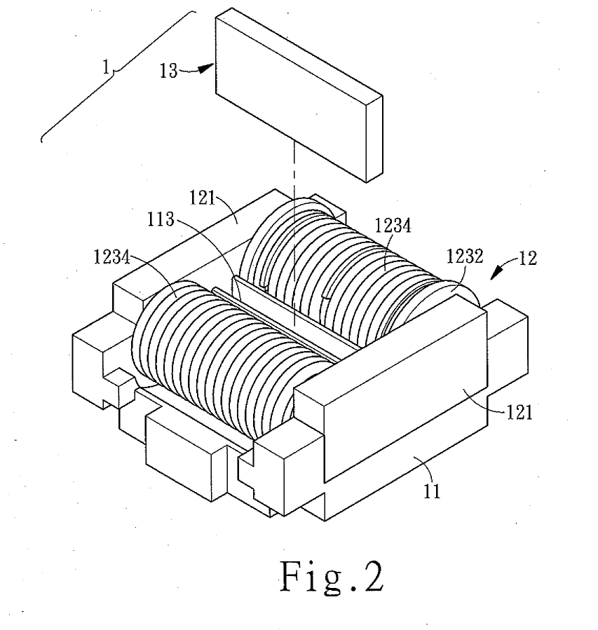

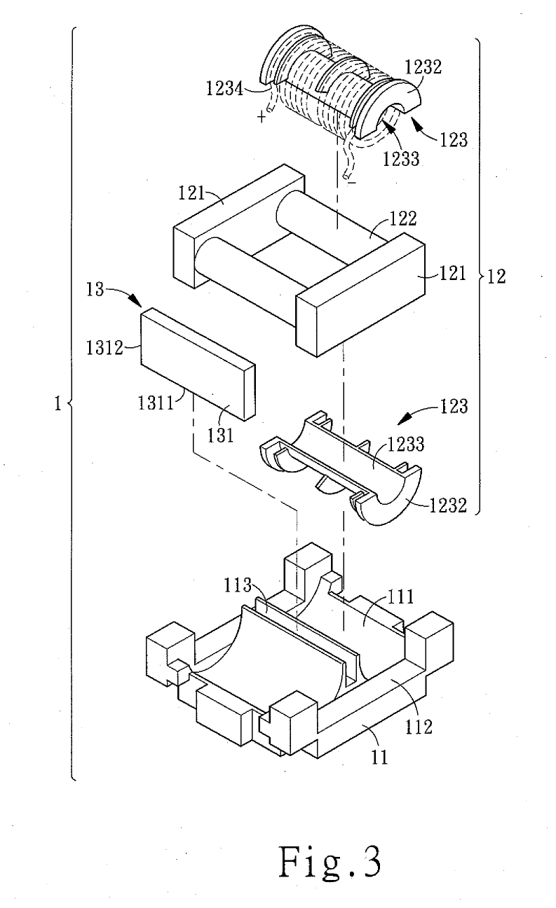

Referring to FIGS. 2 and 3, the complex common mode choke 1 of the transformer 3 in accordance with the preferred embodiment of the present invention comprises a base 11 provided with two receiving recesses 111 and a separation groove 113 located between the two receiving recesses 111, a coil unit 12 mounted on the base 11 and including two coil bobbins 123 each mounted in a respective one of the two receiving recesses 111 of the base 11 and two coils 1234 each mounted on a respective one of the two coil bobbins 123, and an iron core 13 mounted in the separation groove 113 of the base 11 and having two opposite sides 131 each located adjacent to and aligned with a respective one of the two coil bobbins 123 and a respective one of the two coils 1234.

The coil unit 12 further includes two opposite connecting members 121 mounted on the base 11 and two support columns 122 each mounted between the two connecting members 121 and each mounted in a respective one of the two receiving recesses 111 of the base 11. Each of the two connecting members 121 of the coil unit 12 has a substantially rectangular profile. Each of the two support columns 122 of the coil unit 12 has two opposite ends connected to the two connecting members 121. The two support columns 122 of the coil unit 12 are perpendicular to the two connecting members 121.

Each of the two coil bobbins 123 of the coil unit 12 is mounted on a respective one of the two support columns 122 and located between the two connecting members 121. Each of the two coil bobbins 123 of the coil unit 12 consists of two substantially semi-circular shells 1232 juxtaposed to each other sandwich the respective support column 122 between the two semi-circular shells 1232. Each of the two semi-circular shells 1232 of each of the two coil bobbins 123 is provided with a substantially semi-circular receiving space 1233 to receive the respective support column 122.

The base 11 is provided with two opposite fixing slots 112 to receive the two connecting members 121 of the coil unit 12. Each of the two fixing slots 112 of the base 11 extends in a direction that is perpendicular to an axial direction of each of the two receiving recesses 111 and has a substantially rectangular profile. The two receiving recesses 111 and the separation groove 113 of the base 11 are connected to and located between the two fixing slots 112 and are located between the two connecting members 121 of the coil unit 12. Each of the two receiving recesses 111 of the base 11 has a substantially semi-circular profile.

The iron core 13 is made of a magnetic material having a high magnetic conductivity. The iron core 13 is located between the two coils 1234 of the coil unit 12 and is located between the two connecting members 121 of the coil unit 12. The iron core 13 has a substantially rectangular profile and has a length 1311 and a height 1312. Each of the two opposite sides 131 of the iron core 13 has a surface area that is defined by multiplying the length 1311 and the height 1312 of each of the two opposite sides 131 of the iron core 13. The height 1312 of each of the two opposite sides 131 of the iron core 13 extends in a direction that is perpendicular to a extending direction of the separation groove 113 of the base 11.

In practice, when a current passes through each of the two coils 1234 of the coil unit 12, a leakage inductance is produced in the coil unit 12 and between the two coil bobbins 123 of the coil unit 12. Thus, the leakage inductance between the two coil bobbins 123 of the coil unit 12 can be changed by adjusting the surface area of each of the two opposite sides 131 of the iron core 13. In adjustment, the length 1311 of each of the two opposite sides 131 of the iron core 13 has a size that is adjusted to be smaller than that of the separation groove 113 of the base 11 so that a gap is defined between the iron core 13 and the two connecting members 121 of the coil unit 12. In such a manner, the size of the length 1311 of each of the two opposite sides 131 of the iron core 13 is adjusted to be smaller than that of the separation groove 113 of the base 11, and the size of the height 1312 of each of the two opposite sides 131 of the iron core 13 is adjusted to change and adjust the leakage inductance between the two coil bobbins 123 of the coil unit 12. Thus, the leakage inductance of the complex common mode choke 1 between the two coil bobbins 123 of the coil unit 12 can be changed by adjusting the surface area of each of the two opposite sides 131 of the iron core 13, so that the complex common mode choke 1 has a reduced volume and has a lower cost of fabrication.

Accordingly, the iron core 13 is located between the two coils 1234 of the coil unit 12, and the surface area of each of the two opposite sides 131 of the iron core 13 can be adjusted so as to change the leakage inductance between the two coil bobbins 123 of the coil unit 12. In addition, the complex common mode choke 1 of the transformer 3 can replace the common mode choke 22 and the differential mode choke 23 of the conventional transformer 2 so as to reduce the whole volume and decrease the costs of fabrication of the transformer 3 largely.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A complex common mode choke, comprising:
a base provided with two receiving recesses and a separation groove located between the two receiving recesses;
a coil unit mounted on the base and including two coil bobbins each mounted in a respective one of the two receiving recesses of the base and two coils each mounted on a respective one of the two coil bobbins;
an iron core mounted in the separation groove of the base and having two opposite sides each located adjacent to and aligned with a respective one of the two coil bobbins and a respective one of the two coils.

2. The complex common mode choke in accordance with claim 1, wherein the coil unit further includes:
two opposite connecting members mounted on the base;
two support columns each mounted between the two connecting members and each mounted in a respective one of the two receiving recesses of the base.

3. The complex common mode choke in accordance with claim 2, wherein each of the two coil bobbins of the coil unit is mounted on a respective one of the two support columns.

4. The complex common mode choke in accordance with claim 3, wherein each of the two coil bobbins of the coil unit consists of two substantially semi-circular shells juxtaposed to each other sandwich the respective support column between the two semi-circular shells.

5. The complex common mode choke in accordance with claim 4, wherein each of the two semi-circular shells of each of the two coil bobbins is provided with a substantially semi-circular receiving space to receive the respective support column.

6. The complex common mode choke in accordance with claim 2, wherein the base is provided with two opposite fixing slots to receive the two connecting members of the coil unit.

7. The complex common mode choke in accordance with claim 1, wherein the iron core is made of a magnetic material having a high magnetic conductivity.

8. The complex common mode choke in accordance with claim 1, wherein the iron core is located between the two coils of the coil unit.

9. The complex common mode choke in accordance with claim 3, wherein the iron core is located between the two connecting members of the coil unit.

10. The complex common mode choke in accordance with claim 3, wherein
the iron core has a length and a height;
each of the two opposite sides of the iron core has a surface area that is defined by multiplying the length and the height of each of the two opposite sides of the iron core;
when a current passes through each of the two coils of the coil unit, a leakage inductance is produced in the coil unit and between the two coil bobbins of the coil unit;
the leakage inductance between the two coil bobbins of the coil unit can be changed by adjusting the surface area of each of the two opposite sides of the iron core.

11. The complex common mode choke in accordance with claim 10, wherein the height of each of the two opposite sides of the iron core extends in a direction that is perpendicular to a extending direction of the separation groove of the base.

12. The complex common mode choke in accordance with claim 10, wherein the length of each of the two opposite sides of the iron core has a size that is smaller than that of the separation groove of the base.

13. The complex common mode choke in accordance with claim 12, wherein a gap is defined between the iron core and the two connecting members of the coil unit.

14. The complex common mode choke in accordance with claim 6, wherein each of the two fixing slots of the base extends in a direction that is perpendicular to an axial direction of each of the two receiving recesses.

15. The complex common mode choke in accordance with claim 6, wherein the two receiving recesses and the separation groove of the base are connected to and located between the two fixing slots.

16. The complex common mode choke in accordance with claim 6, wherein the two receiving recesses and the separation groove of the base are located between the two connecting members of the coil unit.

17. The complex common mode choke in accordance with claim 4, wherein each of the two receiving recesses of the base has a substantially semi-circular profile.

18. The complex common mode choke in accordance with claim 2, wherein
each of the two support columns of the coil unit has two opposite ends connected to the two connecting members;
the two support columns of the coil unit are perpendicular to the two connecting members.

19. The complex common mode choke in accordance with claim 3, wherein each of the two coil bobbins of the coil unit is located between the two connecting members.

20. The complex common mode choke in accordance with claim 6, wherein
each of the two fixing slots of the base has a substantially rectangular profile;
each of the two connecting members of the coil unit has a substantially rectangular profile.
the iron core has a substantially rectangular profile.
